(19) United States
(12) Patent Application Publication
(10) Pub. No.: US 2015/0075684 A1
(43) Pub. Date: Mar. 19, 2015

(54) CORROSION-RESISTANT AND WATER-PROOF COVERS FOR BARBECUE GRILLS, AUTOMOBILES, OUTDOOR FURNITURE, AND THE LIKE

(71) Applicant: Budge Industries, LLC, Lansdale, PA (US)

(72) Inventors: Charles B. Simon, Bethlehem, PA (US); James W. Thompson, Ambler, PA (US); Daniel B. Simon, Quakertown, PA (US)

(21) Appl. No.: 14/488,250

(22) Filed: Sep. 16, 2014

Related U.S. Application Data
(60) Provisional application No. 61/878,301, filed on Sep. 16, 2013.

(51) Int. Cl. A47J 37/07; B65D 65/02

(52) U.S. Cl. CPC A47J 37/0786; B65D 65/02
USPC 150/165

(57) ABSTRACT

A protective cover for inhibiting corrosion of barbecue grills, automobiles, outdoor furniture, and other metal-containing articles. In one embodiment, the protective cover includes a water vapor-permeable shell and at least one volatile corrosion inhibitor (VCI) disposed on or in the water vapor-permeable shell. The shell includes two outer layers of spunbond polypropylene with an inner layer of polypropylene film impregnated with the VCI. The VCI actively inhibits corrosion, while the entrapment of moisture inside the shell is inhibited by the water vapor-permeable shell.

### CROSS-REFERENCE TO RELATED APPLICATION

This application claims priority to co-pending U.S. Provisional Patent Application Ser. No. 61/878,301, filed Sep. 16, 2013, the disclosure of which is incorporated herein by reference in its entirety.

### BACKGROUND

The disclosure relates, generally, to protective covers, and more particularly, to weather-proof protective covering devices for barbecue grills and other cooking apparatus, automobiles, outdoor furniture, and the like.

While conventional covers protect barbecue grills and other outdoor cooking apparatus, automobiles, outdoor furniture, and the like, against damage from sun, rain, snow, dust, rodents, tree sap, spills, and the like, conventional protective covers provide no protection against rust and corrosion.

In fact, the better a conventional protective cover seals and protects a metal item from external adverse conditions, the more likely that the conventional cover will promote the formation of rust and corrosion on a the metal item by creating an “oversealed” environment within the airspace inside the cover that entraps humidity and moisture.

### SUMMARY

Embodiments of the present disclosure provide protective covers for use with barbecue grills and other outdoor cooking apparatus, automobiles, outdoor furniture, and the like. A protective cover consistent with embodiments of the disclosure can be applied to provide protection against not only rain and other weather elements, but also inhibits the formation of rust and corrosion on metallic components of the item covered by the protective cover.

In one embodiment, the present disclosure provides a protective cover including a water vapor-permeable shell and at least one volatile corrosion inhibitor disposed on or in the water vapor-permeable shell.

In another embodiment, the present disclosure provides a method for inhibiting corrosion of an article. The method includes disposing a protective cover so as to cover at least a portion of the article. The protective cover includes a water vapor-permeable shell and at least one volatile corrosion inhibitor disposed on or in the water vapor-permeable shell.

In a further embodiment, the present disclosure provides a protective cover for an article. The protective cover includes a flexible, water vapor-permeable shell conforming generally to the shape of the article and at least one volatile corrosion inhibitor disposed on or in the water vapor-permeable shell.

### BRIEF DESCRIPTION OF THE DRAWINGS

FIG. 1 shows a front perspective view of a protective cover consistent with a first exemplary embodiment of the disclosure;

FIG. 2 shows details of the construction of the shell of the protective cover of FIG. 1;

FIG. 3 shows a portion of a seam that joins the front section with one of the front side sections of the shell;

FIG. 4 shows a portion of the hem along the bottom edge of the shell;

FIG. 5 shows a portion of the seam that joins the front section with one of the front side sections, including a sewn-in strap that extends from the outer surface of section, for securing the cover to the grill; and

FIG. 6 shows an enlarged view of a portion of the front section, illustrating the two outer layers and one inner layer of material used to form the shell.

### DETAILED DESCRIPTION

Detailed illustrative embodiments of the present disclosure are disclosed herein. However, specific structural and functional details disclosed herein are merely representative for purposes of describing example embodiments of the present disclosure. Embodiments of the present disclosure may be embodied in many alternative forms and should not be construed as limited to only the embodiments set forth herein. Further, the terminology used herein is for the purpose of describing particular embodiments only and is not intended to be limiting of example embodiments of the disclosure.

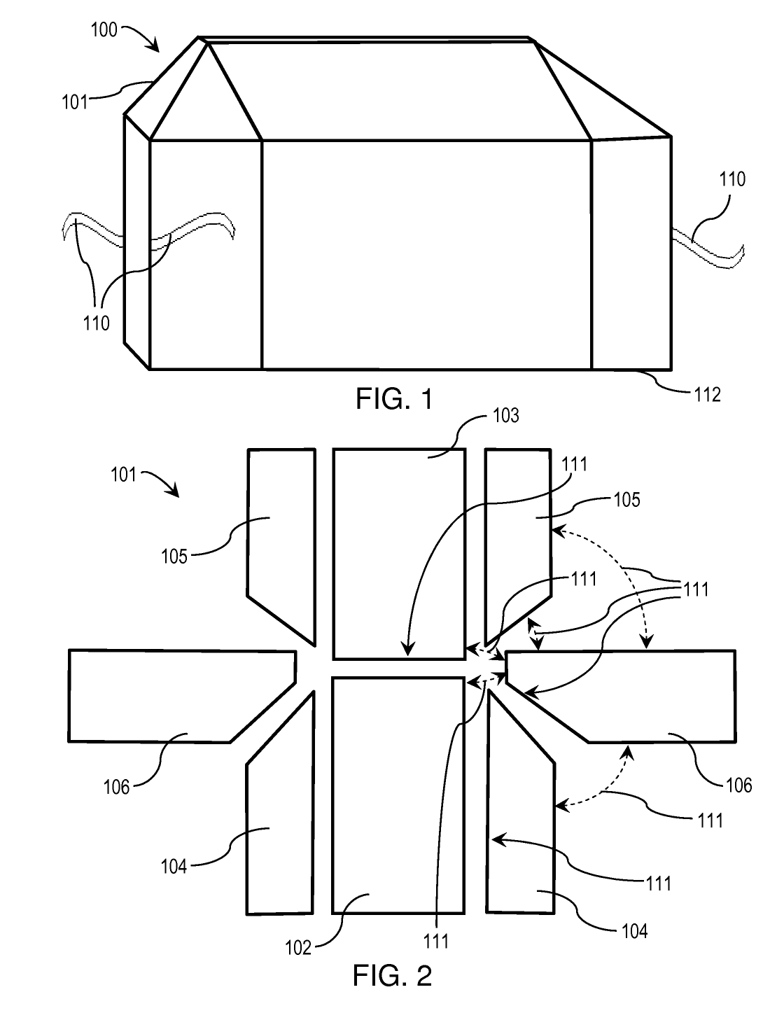

FIG. 1 shows a front perspective view of a protective cover 100 consistent with a first exemplary embodiment of the disclosure. In this embodiment, cover 100 is intended for use with a conventional cart-style barbecue grill up to 60 inches wide, including integral side burners and/or raised drop-leaf side tables or shelves.

As shown, cover 100 includes a water-proof (or at least water-resistant), breathable, corrosion-inhibiting shell 101 and a plurality of straps 110 for fastening cover 100 around the grill. The term “breathable” refers to cover 100 being water vapor-permeable. The term “water-proof” refers to a complete or near inability of water in liquid form to permeate cover 100, while the term “water-resistant” refers to a difficulty or exceptionality of water in liquid form to permeate cover 100. Cover 100 is at least water-resistant and is desirably water-proof as well.

In one exemplary embodiment, shell 101 is an integral member formed by joining a plurality of sections of material via seams 111, as will be explained in further detail below. Shell 101 is desirably flexible, although, in some embodiments, portions of shell 101 may be rigid. Although not visible in FIG. 1, a hem 112 is formed along the bottom edge of shell 101.

FIG. 2 shows details of the construction of shell 101, which includes eight individual sections of material joined together by means of seams 111. The individual sections include a rectangular front section 102, a rectangular rear section 103, two irregular trapezoidal front side sections 104, two irregular trapezoidal rear side sections 105, and two irregular pentagonal side sections 106. Sections 102, 103, 104, 105, and 106 are shown in FIG. 2 as being laid out in plan view, prior to being assembled by means of seams 111 to form shell 101 of protective cover 100. Cover 100 is sewn in such a way as to be substantially water-proof.

While only certain representative areas that are joined by seams 111 are indicated by arrows 111 in FIG. 2, it should be understood that seams 111 are, in fact, used (i) to join section 102 to sections 103 and 104 and to a small portion of section 106, (ii) to join sections 106 to sections 105 and 104, and (iii) to join section 103 to sections 105 and to a small portion of section 106.

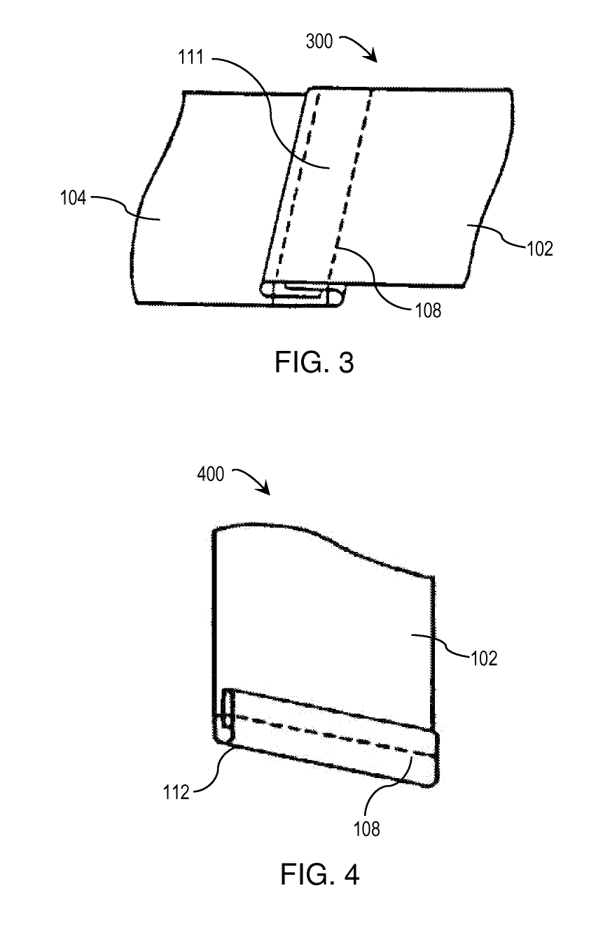

FIG. 3 shows a portion 300 of one such seam 111, which joins front section 102 with one of the front side sections 104. In this embodiment, seams 111 are lapped seams of type LSc-2, although other types of seams may be used in alternative embodiments. As shown in FIG. 3, each lapped seam 111 is formed by folding in and interlapping the edges of the sections 102 and 104 being joined, so that the edges of the material are concealed, and then seaming with one or more rows of stitches 108.

FIG. 4 shows a portion 400 of hem 112, which, in this embodiment, is a bound seam of type EFb-1, although other types of seams may be used in alternative embodiments. As shown in FIG. 4, hem 112 is formed by turning in the edge of the front section 102 being hemmed, folding it back over the body of the material, and stitching the turned and folded portion to the body of the material with one or more rows of stitches 108.

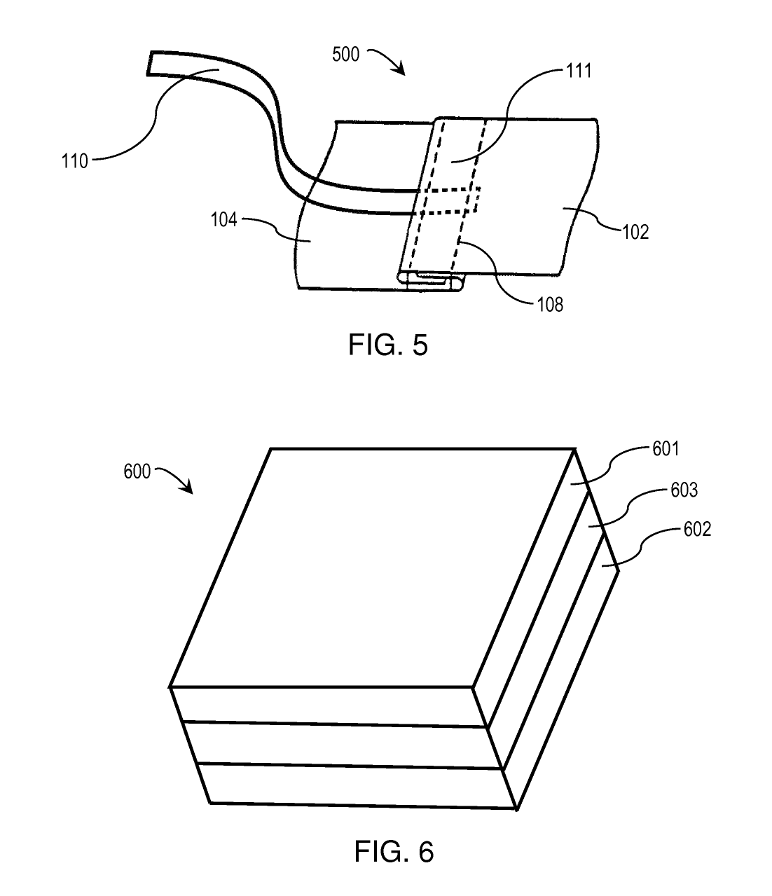

FIG. 5 shows a portion 500 of the seam 111 that joins front section 102 with one of the front side sections 104, showing how one of straps 110 is sewn into seam 111 so as to extend from the outer surface of section 104. The other three straps 110 are attached to shell 101 in like manner. Straps 110 may include, e.g., hook-and-loop fastener, snaps, zippers, buckles, locks or other anti-theft devices, or the like, attached to and/or detachable from shell 101. Alternatively or additionally, one or more cords, elastic members, locks or other anti-theft devices, or similar devices (not shown in the drawings) may be used to secure cover 100 and/or to create a snug fit around the grill.

FIG. 6 shows an enlarged view of a portion 600 of front section 102. In this embodiment, sections 102, 103, 104, 105, and 106 are all constructed from the same type of three-layer fabric, which has two outer layers 601, 602 and an inner layer 603, all arranged so as to permit shell 101 to be water-proof and breathable, as well as inhibit the formation of rust and corrosion on metallic components of the grill covered by protective cover 100. In this embodiment, layers 601, 602, 603 all include 100% polypropylene fabric material.

Outer layers 601, 602, are formed from spunbond polypropylene. Spunbond polypropylene (also called polypropene) is a nonwoven fabric comprising thermally-bonded, continuous polypropylene filaments, providing good filtration properties and tensile strength. Spunbond polypropylene is constructed by spinning continuous filaments of polypropylene and then immediately forming them into a multi-directional arranged web that is heat-bonded at locations where filaments cross one another. In addition to being strong, light, and pleatable, with good drainage and permeability characteristics, spunbond polypropylene is also resistant to moisture and chemical deterioration.

Inner layer 603 is formed from polypropylene film. Inner layer 603, which may be, e.g., micro-porous, spunbond, perforated, and/or biaxially-oriented (e.g., a polyether block amide), is both water-proof and breathable, similar to modern rain jackets. Inner layer 603 also incorporates an active volatile corrosion inhibitor (VCI), which may be provided by impregnation, e.g., depositing the VCI onto the polypropylene film of inner layer 603 at high pressure. The VCI includes, e.g., one or more of nitrates, nitrites, triazoles, carbonates, phosphates, molybdates, aliphatic or aromatic amines, amine salts, ammonium benzoate, alkali dibasic acid salts, tall oil imidazolines, and the like. This VCI in the film actively protects all ferrous and other products contained within cover 100 from corrosion due to exposure to the elements and moisture, through the slow release of compounds within the sealed airspace inside cover 100 that actively inhibit surface corrosion.

When cover 100 is installed onto a grill (or similarly, a car, motorcycle, or other item of value), the VCI evaporates out of the film of the inner layer 603, travels through the grill-facing and/or grill-contacting outer layer 602 of shell 101, and bonds microscopically with any metal surface to create a microscopic layer protecting the metal surface from corrosion caused by oxygen and moisture in the air.

After the cover is removed, the VCI will eventually evaporate from the metal surface of the product. However, the nature of VCIs is such that, when cover 100 is removed from a grill and then subsequently replaced back onto the grill, the previous levels of VCIs within the sealed airspace will eventually return. Whenever cover 100 is installed, active corrosion resistance is provided, e.g., for a period of approximately two years.

In addition to inner layer 603 inhibiting corrosion through emission of VCIs, the three-layer construction of shell 101 also prevents trapped moisture due to the breathability of outer layers 601, 602, unlike conventional grill covers (or vehicle covers, or the like), which are generally designed with the goal of maximizing sealing in order to be water-proof and weather-proof without considering the detrimental effect of oversealing, which traps moisture within the cover. In embodiments of the disclosure, by permitting the article being covered to “breathe” through a water vapor-permeable shell, the cover inhibits corrosion not only on the outside surfaces of the article being covered, but also its interior surfaces (e.g., the wire racks of a grill). Additionally, cover 100 can be configured to “seal” and cover all or substantially all sides and surfaces of a grill (or other article) so as to substantially prevent the entry of rain and other weather elements, without trapping moisture within the “sealed” cover.

In this embodiment, grill cover 100 is designed to fit a particular style of grill. However, it should be understood that a cover consistent with embodiments of the disclosure can alternatively be made in various sizes and shapes to fit other types of grills, as well as other cooking apparatus typically used outdoors, including, e.g., rotisseries, turkey fryers, seafood boilers, and the like, and that the term “grill,” as used herein, should not be construed as limiting in any way. Embodiments of the disclosure may be used, e.g., with barbecue grills fueled by propane, natural gas, and charcoal, rotisseries, roasters, turkey fryers, seafood boilers, smokers, burners, and the like;

Although embodiments of the disclosure are described as being used in connection with cooking apparatus, it should be understood that a protective cover consistent with embodiments of the disclosure may alternatively be used as a protective cover for other items. Embodiments of the present disclosure provide protective covers for use with automobiles, motorcycles, boats, recreational vehicles, snowmobiles, all-terrain vehicles (ATVs), and other vehicles, as well as other items for which protection against corrosion is desirable.

Cover 100 has a shell 101 that is lightweight, strong, durable, UV-protected, and has the look and feel of a standard fabric to which consumers are accustomed. Incorporation of a VCI chemical component into a breathable film as part of an entire fabric structure to protect grills, automobiles, or the like, provides a cover meeting the high demands of consumers, including being water-proof, breathable to prevent mold and mildew, and providing continuous corrosion protection. One or more of layers 601, 602, 603 may also incorporate one or more antibacterial or other antimicrobial chemicals or components, in some embodiments.

In alternative embodiments, instead of employing seams with threads, one or more of seam 111 and hem 112 may be constructed using ultrasonic bonding. In this scenario, an ultrasonic bonding system may be employed, which includes an engraved anvil drum and an ultrasonic system with acoustic stack (e.g., converter, amplitude coupler, and sonotrode). The acoustic stack is mounted above the rotating anvil drum, leaving a small gap between the surface of the rotating anvil and the sonotrode. The sonotrode constantly expands and contracts (amplitude), e.g., at a rate of 20,000 times per second. As material passes through the gap, the material is subjected to force and amplitude. During the expansion cycle, sufficient compression is applied through the material against the raised bonding points of the anvil drum, which creates surface friction that melts the woven or nonwoven materials being bonded. During the contraction cycle, the gap increases, so that the material can move through the gap without jamming. The strength of the ultrasonic bond depends on based on the constantly-controlled speed of the material, the constant amplitude, and a consistent force applied to a specific anvil drum pattern.

It should be understood that the locations of the seams shown in FIG. 1 and the types of seams and bonding methods shown in FIGS. 3-5 are merely exemplary, and that other locations and types of seams and bonding methods may be used in alternative embodiments.

In alternative embodiments, shell 101 may include additional materials, e.g., polyester, nylon, a poly-acrylic, polyurethane, PEVA, and/or PVC material, or the like. Other fibers that provide similar physical properties may be used for one or more of outer layers 601, 602 and/or inner layer 603 in alternative embodiments. For example, water-proof breathable materials used may additionally or alternatively include one or more of: a hydrophobic microporous expanded polytetrafluoroethylene (PTFE) membrane, a hydrophilic monolithic polyurethane (PU) membrane, a hydrophilic monolithic expanded PTFE membrane used in conjunction with a PU membrane, an expanded PTFE membrane with oleophobic properties, a microporous polypropylene laminate, a hydrophobic microporous water-proof breathable polyurethane, and a monolithic, co-polyester (Co-PET) breathable film adapted to transport moisture vapor without having pores formed therein.

Although embodiments of a cover have been disclosed herein, wherein the cover has an inner polypropylene film layer including a VCI material, disposed between two outer polypropylene layers, it should be understood that the disclosure should be interpreted as including other embodiments of covers having fabric materials that incorporate VCI materials as well. For example, an outer or an inner layer of fabric, or both, may include a VCI material. Multiple layers of fabric may include VCI materials. More than one type of VCI material may be used. Fewer or more than three layers of fabric may be used. In one embodiment, the shell includes only a single layer of fabric incorporating a VCI material, without any additional layers of fabric or other materials present.

It should be understood that various changes in the details, materials, and arrangements of the parts which have been described and illustrated in order to explain the nature of this disclosure may be made by those skilled in the art without departing from the scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure has been described using relative terms such as “front,” “back,” “side,” “top,” “bottom,” “over,” “above,” “under” and the like in the description and in the claims, such terms are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Although the disclosure has been set forth in terms of the exemplary embodiments described herein and illustrated in the attached drawings, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A protective cover comprising:
a water vapor-permeable shell; and
at least one volatile corrosion inhibitor disposed on or in the water vapor-permeable shell.

2. The protective cover of claim 1, wherein the shell comprises polypropylene.

3. The protective cover of claim 2, wherein the shell includes at least one spunbond polypropylene layer.

4. The protective cover of claim 1, wherein the shell includes two outer layers of material and an inner layer of material disposed between the outer layers, wherein the volatile corrosion inhibitor is disposed on or in the inner layer of material.

5. The protective cover of claim 4, wherein the outer layers comprise spunbond polypropylene and the inner layer comprises polypropylene film.

6. The protective cover of claim 1, wherein the shell comprises eight sections of material joined by seams.

7. The protective cover of claim 6, wherein the shell comprises two rectangular sections of material, four irregular trapezoidal sections of material, and two irregular pentagonal sections of material, joined together.

8. The protective cover of claim 1, wherein the protective cover is water-resistant or water-proof.

9. The protective cover of claim 1, wherein the protective cover conforms generally to the shape of a cooking apparatus.

10. The protective cover of claim 1, wherein the cooking apparatus is a cart-style barbecue grill.

11. The protective cover of claim 1, wherein the protective cover conforms generally to the shape of a vehicle.

12. The protective cover of claim 1, wherein the protective cover conforms generally to the shape of an article of furniture.

13. The protective cover of claim 1, wherein the protective cover is adapted to release one or more corrosion-inhibiting compounds within a sealed airspace inside the protective cover, when the protective cover is in use.

14. The protective cover of claim 1, further comprising one or more straps to secure the protective cover around an article.

15. The protective cover of claim 1, wherein the volatile corrosion inhibitor includes one or more: nitrates, nitrites, triazoles, carbonates, phosphates, molybdates, aliphatic or aromatic amines, amine salts, ammonium benzoate, alkali dibasic acid salts, and tall oil imidazolines.

16. The protective cover of claim 1, wherein the shell comprises one or more of: a hydrophobic microporous expanded polytetrafluoroethylene (PTFE) membrane, a hydrophilic monolithic polyurethane (PU) membrane, a hydrophilic monolithic expanded PTFE membrane used in conjunction with a PU membrane, an expanded PTFE membrane with oleophobic properties, a microporous polypropylene laminate, a hydrophobic microporous water-proof breathable polyurethane, and a monolithic, co-polyester (Co-PET) breathable film adapted to transport moisture vapor without having pores formed therein.

17. The protective cover of claim 1, wherein the shell comprises at least one antibacterial or antimicrobial component.

18. The protective cover of claim 6, wherein at least one of the seams is constructed using ultrasonic bonding.

19. A method for inhibiting corrosion of an article, the method comprising:
disposing a protective cover so as to cover at least a portion of the article, the protective cover comprising:
a water vapor-permeable shell; and
at least one volatile corrosion inhibitor disposed on or in the water vapor-permeable shell.

20. A protective cover for an article, the protective cover comprising:
a flexible, water vapor-permeable shell conforming generally to the shape of the article; and
at least one volatile corrosion inhibitor disposed on or in the water vapor-permeable shell.
